(19) United States
(12) Patent Application Publication
(10) Pub. No.: US 2018/0045466 A1
(43) Pub. Date: Feb. 15, 2018

(54) GAS EXHAUSTING SYSTEM AND METHOD FOR EXHAUSTING GAS

(71) Applicant: TANGTECK EQUIPMENT INC., TAOYUAN COUNTY (TW)

(72) Inventors: MING-HUI YU, TAIPEI CITY (TW); A-TZU CHEN, NEW TAIPEI CITY (TW); WANG-TSUNG LIANG, TAOYUAN COUNTY (TW); CHANG-FA CHEN, TAOYUAN COUNTY (TW)

(21) Appl. No.: 15/677,132

(22) Filed: Aug. 15, 2017

(30) Foreign Application Priority Data
Aug. 15, 2016 (TW) 105125928

(51) Int. Cl. F27D 17/00

(52) U.S. Cl. CPC F27D 17/002

(57) ABSTRACT

A gas exhausting system includes at least two gas exhausting modules. The at least two gas exhausting modules are disposed on a heating furnace, and arranged at a front position and a rear position separately along a transporting direction of the heating furnace. Each gas exhausting module has a casing and an exhausting channel. The exhausting channel is arranged in the casing, and has an opening end. The opening end of the exhausting channel is lower than the second end of the casing. The exhausting channel is connected to a blowing machine. When the blowing machine is driven, gas is propelled into the exhausting channel, and hyperbaric gas can be exhausted upward from the opening end of the exhausting channel. The gas with higher flow velocity can provide a siphonic action, so as to accelerate gas to be exhausted from the heating furnace.

### BACKGROUND OF THE INVENTION

### 1. Field of the Invention

The present disclosure is related to a gas exhausting system and a method for exhausting gas. In particular, the present disclosure relates to a gas exhausting system disposed in an exhaust pending region of a heating furnace for accelerating gas exhaust, with better gas exhaust efficiency, and a method for exhausting gas.

### 2. Description of Related Art

A heating furnace can be used to heat a workpiece to be processed. The heating furnace has a proper delivery structure to transport the workpiece to pass through an inside of the furnace body, and heats the workpiece by a heater. When the heating furnace is operating, it gives off waste gas. Thus, a gas exhausting device is needed to properly discharge the exhaust gas for avoiding endangering human health. The current gas exhausting device has an exhaust pipe. One end of the exhaust pipe is connected to an exhaust pending region, so that the waste gas can be discharged through the exhaust pipe after the burning process. However, the gas exhausting performance of current gas exhausting devices usually is poor, and the waste gas remained in the furnace body of the heating furnace may react with the workpiece. Consequently, the appearance and characteristics of the workpiece are affected due to the waste gas, resulting in reduced product yield.

Hence, the inventor of the present disclosure believes that the above mentioned disadvantages can be overcome, and has been studying and working on the case. Finally the present disclosure which has a better design is proposed to effectively improve the above mentioned disadvantages.

### SUMMARY OF THE INVENTION

One of the objectives of the present disclosure is to provide a gas exhausting system and a method for exhausting gas, which can enhance the performance of gas exhaust and prevent the waste gas from affecting the appearance and characteristics of the workpiece.

In order to achieve the above objectives, according to one exemplary embodiment of the present disclosure, a gas exhausting system is provided and is disposed in a heating furnace. The heating furnace has a furnace body. A workpiece is transported in the furnace body along a transporting direction. The gas exhausting system includes at least two gas exhausting modules. The at least two gas exhausting modules are disposed on the heating furnace, and respectively arranged at a front position and a rear position along the transporting direction of the heating furnace. Each gas exhausting module has a casing and an exhausting channel. The casing has two ends which are respectively defined as a first end and a second end. The first end and the second end are opened. The first end is connected to an exhaust pending region in the furnace body of the heating furnace. The exhausting channel has an opening end formed at an upper end thereof. The opening end of the exhausting channel is lower than the second end of the casing. One side of the exhausting channel is formed with a lateral opening, and the lateral opening is connected to a blowing machine. The blowing machine is capable of propelling air into the exhausting channel, so as to upward output a hyperbaric gas through the opening end of the exhausting channel, and accelerate the waste gas to be exhausted in the furnace body.

In order to achieve the above objectives, according to one exemplary embodiment of the present disclosure, a method for exhausting gas is provided and includes the steps as follows: providing a gas exhausting system in a heating furnace, the heating furnace having a furnace body to process a workpiece, the workpiece being movable in the furnace body along a transporting direction; wherein the gas exhausting system includes at least two gas exhausting modules disposed on the heating furnace, and respectively at a front position and a rear position of the heating furnace along the transporting direction; wherein each of the gas exhausting modules includes a casing and an exhausting channel, the casing having two ends respectively defined as a first end and a second end, the first end and the second end being opened, the first end connected to an exhaust pending region in the furnace body of the heating furnace, the exhausting channel having an upper end formed with an opening end; wherein the opening end of the exhausting channel is lower than the second end of the casing, and the exhausting channel has one side formed with a lateral opening, the lateral opening being connected to a blowing machine; and driving the blowing machine of the at least two gas exhausting modules to propel air into the exhausting channel of the at least two gas exhausting modules, so as to upward output a hyperbaric gas through the opening end of the exhausting channel of the at least two gas exhausting modules; when the hyperbaric gas is upward outputted through the opening end of the exhausting channel of the at least two gas exhausting modules, the gas with higher flow velocity providing a siphonic action for waste gas in the casing, so as to accelerate the waste gas to be exhausted from the furnace body of the heating furnace.

According to one exemplary embodiment of the present disclosure, the at least two gas exhausting modules are spaced out along the transporting direction on the heating furnace. The at least two gas exhausting modules are separately arranged at an upstream position and a downstream position respectively for exhausting gases from different temperature regions. A region temperature of the gas exhausting module at the downstream position is higher than a region temperature of the gas exhausting module at the upstream position.

According to one exemplary embodiment of the present disclosure, the gas exhausting module has a sensing device. The sensing device includes at least one of a temperature sensor, an aerometer and a gas sensor.

Thus, the present disclosure has advantages as follows. The at least two gas exhausting modules are disposed in the heating furnace, and are respectively arranged at a front position and a rear position of the heating furnace along the transporting direction, so that better gas exhaust efficiency can be achieved. Moreover, the gas exhausting modules are disposed separately and arranged at the front position and the rear position respectively, so that they can exhaust gas from different temperature regions. Therefore, the present disclosure enables the waste gases produced separately at different temperatures to be exhausted from the heating furnace in a regional manner and in a classified manner. The present disclosure can prevent waste gas from reacting with the workpiece, and avoid waste gas affecting the appearance and characteristic of the workpiece, so as to increase the product yield of the workpiece. Furthermore, the classified waste gases are easily to be processed.

For further understanding of the present disclosure, reference is made to the following detailed description illustrating the embodiments and examples of the present disclosure. The description is for illustrative purpose only and is not intended to limit the scope of the claim.

### BRIEF DESCRIPTION OF THE DRAWINGS

FIG. 1 is a schematic diagram of a gas exhausting system according to the present disclosure;

FIG. 2 is a partial enlarged view of part B in FIG. 1 according to the present disclosure;

FIG. 3 is a cross-sectional view of the gas exhausting module according to the present disclosure;

FIG. 4 is a perspective view of the gas exhausting module according to the present disclosure;

FIG. 5 is a perspective view of the gas exhausting module exhausting gas according to the present disclosure; and

FIG. 6 is a flow chart of a method for exhausting gas according to the present disclosure.

### DETAILED DESCRIPTION OF THE EXEMPLARY EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

### First Embodiment

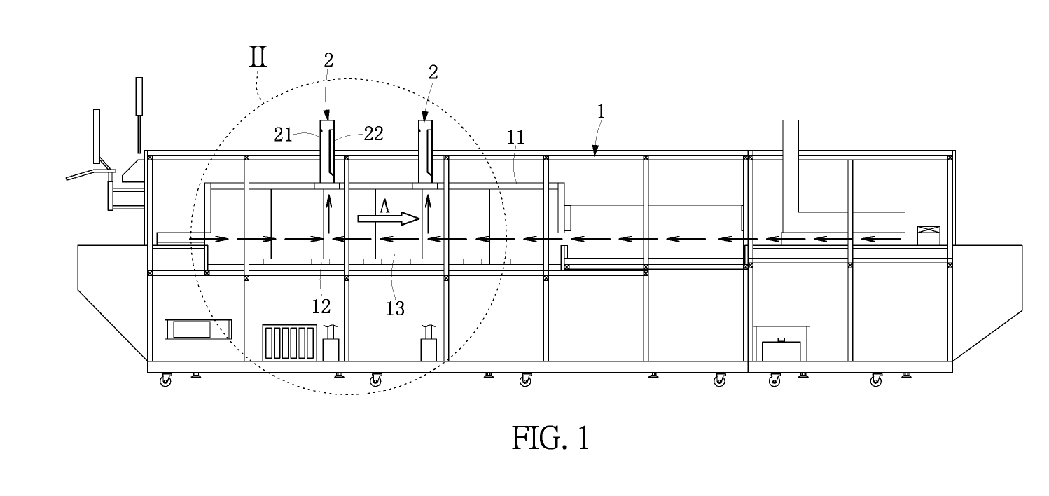

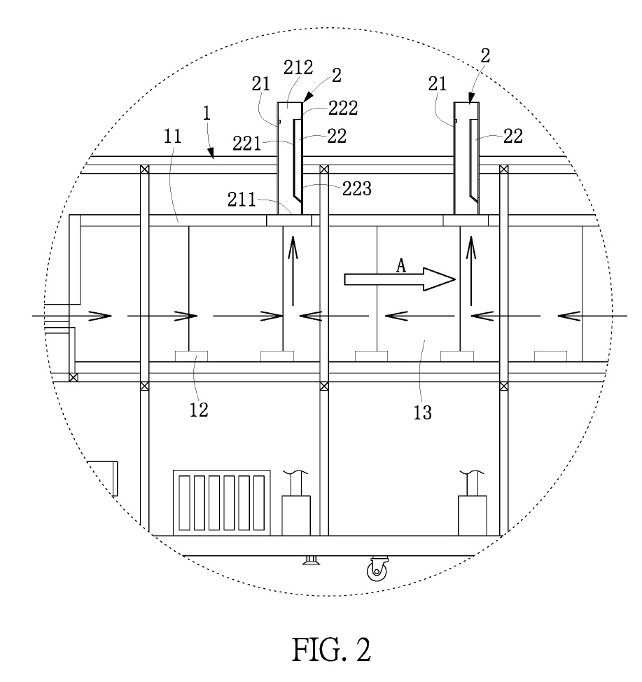

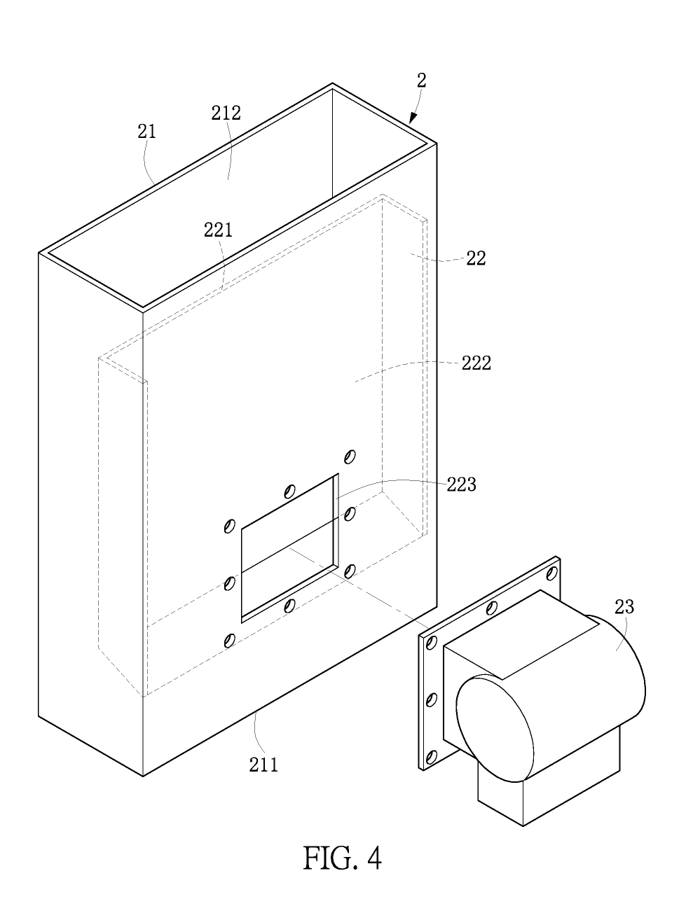

Reference is made to FIGS. 1 to 4. The present disclosure provides a gas exhausting system, which is arranged in a heating furnace 1. The type and structure of the heating furnace 1 are not limited thereto. For example, it can be a continuous heating furnace. The heating furnace 1 has a furnace body 11, and the furnace body 11 can be equipped with a plurality of heaters 12 for heating a workpiece. The structure of the heater 12 can be, for example an electrical heater . . . etc., and is not limited thereto. The heating furnace 1 has a useful transporting structure for transporting the workpiece. The workpiece is able to be transported in the furnace body 11 along a transporting direction A. The workpiece can be inputted from one end (such as a left end of FIG. 1) of the furnace body 11, and outputted from the other end (such as a right end of FIG. 1) of the furnace body 11. The two ends of the heating furnace 1 can be further inputted a positive pressure airflow, so as to accelerate the gas exhaust.

The gas exhausting system includes at least two gas exhausting modules 2. The at least two gas exhausting modules 2 are disposed on the heating furnace 1, and respectively arranged at a front position and a rear position of the heating furnace 1 along the transporting direction A. That is, the at least two gas exhausting modules 2 are separately arranged on the heating furnace 1 along the transporting direction A. However, the amount of the gas exhausting modules 2 is not limited, three, four or five or more can be provided.

Each gas exhausting module 2 includes a casing 21 and an exhausting channel 22. The casing 21 is a hollow casing made of a metallic board. The casing 21 has two ends which are respectively defined as a first end 211 and a second end 212. The first end 211 and the second end 212 are opened, and in this embodiment, they are formed at a lower part and an upper part of the casing 21, respectively. The first end 211 is connected to an exhaust pending region 13 in the furnace body 11 of the heating furnace 1. The first end 211 can be directly connected to the exhaust pending region 13 in the heating furnace 1, or the first end 211 can be connected to the exhaust pending region 13 in the heating furnace 1 by a pipe . . . etc. (not shown), so that an interior of the casing 21 is communicated with the exhaust pending region 13 in the heating furnace 1. The exhaust pending region 13 is formed in the furnace body 11 of the heating furnace 1, and the casing 21 can be formed with an exhausting pipe, so that the waste gas in the heating furnace 1 can be guided and upward expelled through the second end 212 of the casing 21.

The exhausting channel 22 is disposed in the casing 21. The exhausting channel 22 can be partitioned in the casing 21 by arranging a partition wall 221. The partition wall 221 can partition off the interior of the casing 21 to form the exhausting channel 22. An upper end of the exhausting channel 22 is formed with an opening end 222, and the opening end 222 of the exhausting channel 22 is lower than the second end 212 of the casing 21. The exhausting channel 22 has one side which is formed with a lateral opening 223, and the lateral opening 223 is communicated with an external environment. In addition, the lateral opening 223 is connected to a blowing machine 23. The lateral opening 223 can be directly connected to the blowing machine 23, or the lateral opening 223 can be connected to the blowing machine 23 by a pipe (not shown).

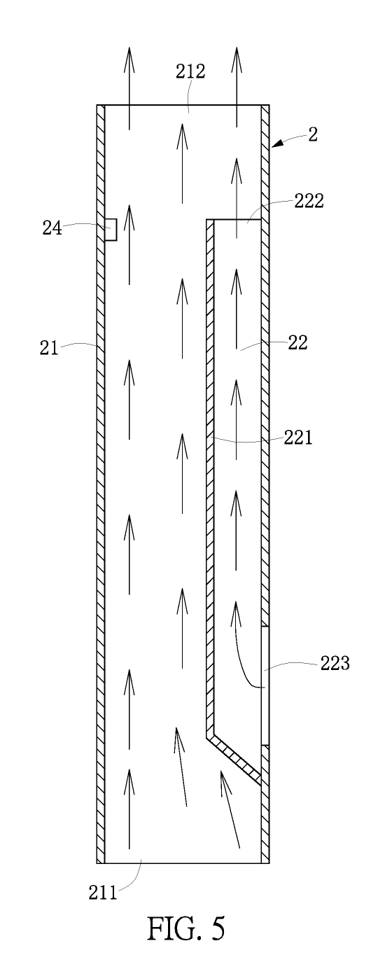

When the blowing machine 23 is driven, the blowing machine 23 can propel air into the exhausting channel 22, so as to upward output a hyperbaric gas through the opening end 222 of the exhausting channel 22, as shown in FIG. 5. When the hyperbaric gas is upward outputted from the opening end 222, the gas with higher flow velocity can provide a siphonic action for waste gas in the casing 21, so as to accelerate the waste gas to be exhausted from the furnace body 11 of the heating furnace 1. Thus, better gas exhaust efficiency can be achieved. According to the present disclosure, the interior of the casing 21 is formed with the exhausting channel 22 in a partitioned manner. The exhausting channel 22 is separated from the interior space of the casing 21 by the partition wall 221. When waste gas is discharged through the interior of the casing 21, residues will not remain in the exhausting channel 22, and the opening end 222 of the exhausting channel 22 has a larger sectional area. Therefore, the exhausting channel 22 will not be choked. Moreover, by using the blowing machine 23 to output the hyperbaric gas, the cost can be lowered.

According to the present disclosure, the at least two gas exhausting modules 2 are disposed at a front and a rear positions respectively along the transporting direction A of the heating furnace 1. In other words, at least two gas exhausting modules 2 are separately arranged at an upstream position and a downstream position respectively, so that they can exhaust gases from different temperature regions. A region temperature of the gas exhausting module 2 at the upstream position is higher than a region temperature of the gas exhausting module 2 at the downstream position. For example, the gas exhausting module 2 at the upstream position and the gas exhausting module 2 at the downstream position can be disposed in a region at 350 degrees Celsius and in a region at 450 degrees Celsius, respectively. When the workpiece is heated in the two different temperature regions, different waste gases and reaction products are produced. Take a circuit board for example, the organic compound materials, such as plasticizer, solvent etc. will produce different waste gases and reaction products in different temperature conditions.

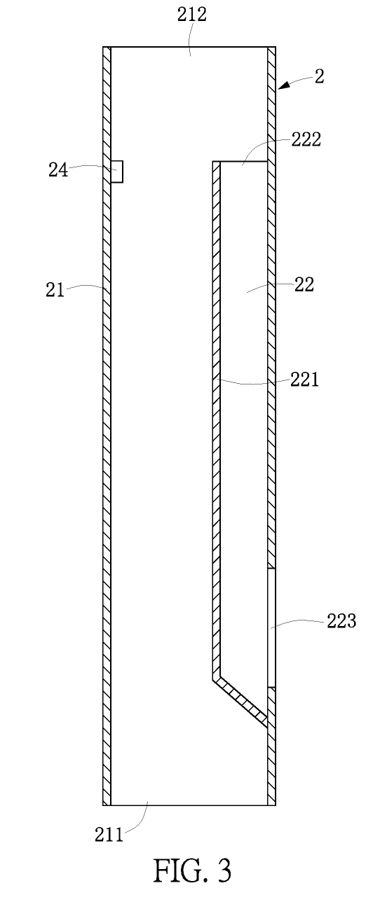

The gas exhausting module 2 can further include a sensing device 24, as shown in FIG. 3. The sensing device 24 can be disposed in the casing 21 of the gas exhausting module 2 or in the exhausting channel 22. In this embodiment, the sensing device 24 is disposed in the casing 21 of the gas exhausting module 2. The sensing device 24 can include at least one of a temperature sensor, an aerometer or a gas sensor, which is used to monitor data of waste gas, so as to ensure whether the system stability and adjustment are correct or not. For example, the temperature sensor can be used to detect the gas temperature; the aerometer can be used to detect the gas velocity for understanding the gas exhausting condition and whether the blowing machine 23 functions normally or not; and the gas sensor can be a CO sensor, a CO₂ sensor, a H₂O sensor or a O₂ sensor respectively detecting CO, CO₂, H₂O and O₂ contained in waste gas. The gas sensor also can be a VOCs sensor, which can be used to detect the volatile organic compounds (VOCs).

### Second Embodiment

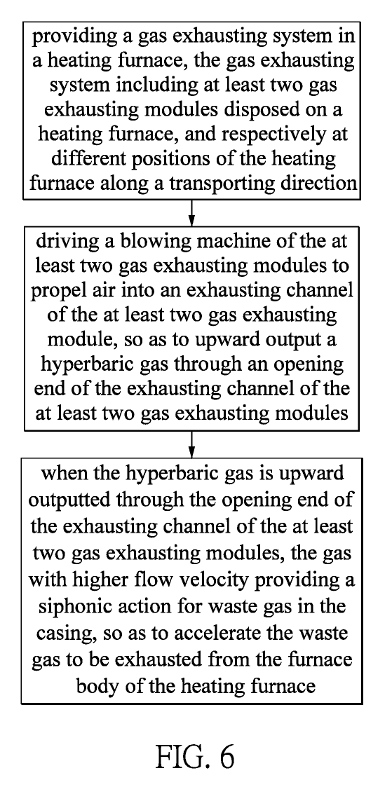

Reference is made to FIG. 6. The present disclosure provides a method for exhausting gas, particularly related to a method for exhausting gas from the exhaust pending region of the heating furnace, which can accelerate exhausting waste gas. The method includes the steps as follows.

A gas exhausting system as shown in FIG. 1 to FIG. 5 is provided, and the gas exhausting system includes at least two gas exhausting modules 2. The at least two gas exhausting modules 2 are disposed on the heating furnace 1, and are respectively arranged at a front position and a rear position of the heating furnace 1 along the transporting direction A. Each gas exhausting module 2 has a casing 21 and an exhausting channel 22. The casing 21 has two ends which are respectively defined as a first end 211 and a second end 212. The first end 211 and the second end 212 are opened. The first end 211 is connected to an exhaust pending region 13 in the furnace body 11 of the heating furnace 1. An upper end of the exhausting channel 22 is formed with an opening end 222, and the opening end 222 of the exhausting channel 22 is lower than the second end 212 of the casing 21. The exhausting channel 22 has one side which is formed with a lateral opening 223, and the lateral opening 223 is connected to a blowing machine 23. The gas exhausting system provided in the present embodiment is the same as that mentioned in the above embodiment, and it is thus not described here in detail.

Then, the method includes: driving the blowing machine 23 of the at least two gas exhausting modules 2 to propel air into the exhausting channel 22 of the at least two gas exhausting modules 2, so that a hyperbaric gas is upward outputted through the opening end 222 of the exhausting channel 22 of the at least two gas exhausting modules 2, as shown in FIG. 5.

When the hyperbaric gas is upward outputted through the opening end 222 of the exhausting channel 22 of the at least two gas exhausting modules 2, the gas with higher flow velocity can provide a siphonic action for waste gas in the casing 21, so as to accelerate the waste gas to be exhausted from the furnace body 11 of the heating furnace 1.

To sum up, according to the present disclosure, the at least two gas exhausting modules are disposed in the heating furnace, and are respectively arranged at a front position and a rear position of the heating furnace along the transporting direction, so that better gas exhaust efficiency can be achieved. Moreover, the gas exhausting modules are disposed separately and arranged at the front position and the rear position respectively, so that they can exhaust gas from different temperature regions. When the workpiece is heated in the two different temperature regions, different waste gases and reaction products are produced. Therefore, the present disclosure enables the waste gases produced separately at different temperatures to be exhausted from the heating furnace in a regional manner and in a classified manner. The present disclosure can prevent waste gas from reacting with the workpiece, and avoid waste gas affecting the appearance and characteristic of the workpiece, so as to increase the product yield of the workpiece. Furthermore, the classified waste gases are easily to be processed.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A gas exhausting system, disposed in a heating furnace, the heating furnace having a furnace body to process a workpiece, the workpiece being movable in the furnace body along a transporting direction, the gas exhausting system comprising:
at least two gas exhausting modules, disposed on the heating furnace at a front and a rear positions respectively along a transporting direction of the heating furnace, wherein each of the gas exhausting modules has a casing and an exhausting channel, and two ends of the casing are respectively defined as a first end and a second end, the first end and the second end being opened, the first end being connected to an exhaust pending region in the furnace body of the heating furnace, the exhausting channel having an opening end formed on an upper end thereof, the opening end of the exhausting channel being lower than the second end of the casing, one side of the exhausting channel being formed with a lateral opening, the lateral opening connected with a blowing machine, wherein the blowing machine is capable of propelling air into the exhausting channel, and a hyperbaric gas is upward outputted through the opening end of the exhausting channel, so as to accelerate the gas to be exhausted from the furnace body; wherein two ends of the furnace body of the heating furnace are inputted with positive pressure airflows; wherein the at least two gas exhausting modules are capable of exhausting gases in different temperature regions of the furnace body of the heating furnace, so as to exhaust waste gases separately produced at different temperatures from the heating furnace in a regional manner and in a classified manner.

2. The gas exhausting system as claimed in claim 1, wherein the gas exhausting module has a sensing device, and the sensing device includes at least one of a temperature sensor, an aerometer and a gas sensor.

3. The gas exhausting system as claimed in claim 2, wherein the sensing device is disposed in the casing of the gas exhausting module or in an interior of the exhausting channel.

4. The gas exhausting system as claimed in claim 1, wherein the at least two gas exhausting modules are separately disposed on the heating furnace along the transporting direction, and the at least two gas exhausting modules are arranged at an upstream position and a downstream position respectively, so as to exhaust gases from different temperature regions; wherein a region temperature of the gas exhausting module at the downstream position is higher than a region temperature of the gas exhausting module at the upstream position of the gas exhausting module.

5. A method for exhausting gas, comprising steps as follows:
providing a gas exhausting system in a heating furnace, the heating furnace having a furnace body to process a workpiece, the workpiece being movable in the furnace body along a transporting direction; wherein the gas exhausting system includes at least two gas exhausting modules disposed on the heating furnace, and respectively at a front position and a rear position of the heating furnace along the transporting direction; wherein each of the gas exhausting modules includes a casing and an exhausting channel, the casing having two ends respectively defined as a first end and a second end, the first end and the second end being opened, the first end connected to an exhaust pending region in the furnace body of the heating furnace, the exhausting channel having an upper end formed with an opening end; wherein the opening end of the exhausting channel is lower than the second end of the casing, and the exhausting channel has one side formed with a lateral opening, the lateral opening being connected to a blowing machine; and
driving the blowing machine of the at least two gas exhausting modules to propel air into the exhausting channel of the at least two gas exhausting modules, so as to upward output a hyperbaric gas through the opening end of the exhausting channel of the at least two gas exhausting modules; wherein two ends of the furnace body of the heating furnace are inputted with positive pressure airflows;
when the hyperbaric gas is upward outputted through the opening end of the exhausting channel of the at least two gas exhausting modules, the gas with higher flow velocity providing a siphonic action for waste gas in the casing, so as to accelerate the waste gas to be exhausted from the furnace body of the heating furnace; wherein the at least two gas exhausting modules are capable of exhausting gases in different temperature regions of the furnace body of the heating furnace, so as to exhaust waste gases separately produced at different temperatures from the heating furnace in a regional manner and in a classified manner.

6. The method for exhausting gas as claimed in claim 5, wherein the gas exhausting module has a sensing device, and the sensing device includes at least one of a temperature sensor, a aerometer and a gas sensor.

7. The method for exhausting gas as claimed in claim 6, wherein the sensing device is disposed in the casing of the gas exhausting module or in an interior of the exhausting channel.

8. The method for exhausting gas as claimed in claim 5, wherein the at least two gas exhausting modules are separately disposed on the heating furnace along the transporting direction, the at least two gas exhausting modules arranged at an upstream position and a downstream position respectively, so as to exhaust gases from different temperature regions; wherein a region temperature of the gas exhausting module at the downstream position is higher than a region temperature of the gas exhausting module at the upstream position of the gas exhausting module.
